(19) United States
(12) Patent Application Publication
(10) Pub. No.: US 2014/0122044 A1
(43) Pub. Date: May 1, 2014

(54) HARVEST-TIME RIPENESS ESTIMATION DEVICE, HARVEST-TIME RIPENESS ESTIMATION METHOD AND PROGRAM

(71) Applicant: Nobuyuki Yasukawa, Tokyo (JP)

(72) Inventor: Nobuyuki Yasukawa, Tokyo (JP)

(73) Assignee: NEC CORPORATION, Tokyo (JP)

(21) Appl. No.: 14/126,261

(22) PCT Filed: Feb. 28, 2012
(86) PCT No.: PCT/JP2012/054872

§ 371 Date: Dec. 13, 2013

(30) Foreign Application Priority Data
Jun. 17, 2011 (JP) 2011-135385

(51) Int. Cl. G06F 17/50

(52) U.S. Cl. CPC G06F 17/5009
USPC 703/6

(57) ABSTRACT

The present invention estimates information indicating ripeness at harvest time at a stage after the harvest time. A harvest-time ripeness estimation device includes: a first optical data acquisition unit configured to acquire first optical data obtained by applying light of a first wavelength to a fruit or vegetable at a first time point after harvest time of the fruit or vegetable; a harvest-time ripeness correspondence information storage unit configured to store harvest-time ripeness correspondence information indicating correspondence relation between ripeness at the harvest time of the fruit or vegetable and a value of the first optical data with respect to the light of the first wavelength; and a harvest-time ripeness estimation unit configured to estimate the ripeness at the harvest time of the fruit or vegetable on the basis of the acquired first optical data and the harvest-time ripeness correspondence information.

### BACKGROUND

The present invention relates to a harvest-time ripeness estimation device, a harvest-time ripeness estimation method and a program.

Recently, various technologies of non-destructively measuring the quality of food such as fruit and vegetables have been proposed. For example, Patent Document 1 and Non-Patent Document 1 disclose a method of measuring the quality of fruit and vegetables and the like on the basis of imaging data. Patent Document 2 discloses a method of measuring the ripeness of crops at the harvest time of the crops. Patent Document 3 discloses a method of predicting future quality on the basis of present quality. Non-Patent Documents 2 and 3 disclose a method of predicting the deterioration rate of the quality of fruit and vegetables and the like on the basis of imaging data.
Patent Document 1: Patent Publication JP2009-294144A
Patent Document 2: Patent Publication JP2006-055744A
Patent Document 3: Patent Publication JP2004-215890A
Non-Patent Document 1: “HSC Shooting Case”, [online], Eva Japan Co., Ltd., [Searched on Jun. 7, 2011], Internet <URL:http://www.ebajapan.jp/hsc 1701/case/food.html>
Non-Patent Document 2: “Fading Velocity Prediction of Broccoli Flower Bud Portions Using Hyperspectral Camera”, p. 82, Abstracts of 2010 Annual Meeting of The Spectroscopical Society of Japan, Yoshio Makino, Yumi Kosaka, Yoshinori Kawagoe, Seiichi Oshita, The Spectroscopical Society of Japan, Nov. 20, 2010
Non-Patent Document 3: “Effects of Post-harvest Changes in Quality of Broccoli on Temporal Change of Two-dimensional Spectral Reflectance Spectrum”, pp. 54-55, 46th Annual Report of The Japanese Society of Agricultural Machinery Kanto Regional Unit, Yoshio Makino, Yumi Kosaka, Yoshinori Kawagoe, Seiichi Oshita, The Japanese Society of Agricultural Machinery Kanto Regional Unit, Aug. 5, 2010

A quality transition model indicating the transition of quality over time involves not only current information but also ripeness at harvest time. Therefore, information indicating the ripeness at the harvest time is needed in order to improve prediction performance of future quality.

However, the methods disclosed in Patent Document 1, Non-Patent Document 1, and Patent Document 2 enable only measurement of quality or ripeness at the time of measurement, and it is impossible to obtain the information indicating the ripeness at harvest time at a stage after the harvest time by such methods. Additionally, Patent Document 3 discloses that future quality is predicted on the basis of current quality, but does not disclose that the information indicating the ripeness at harvest time is obtained at a time point after the harvest time.

### SUMMARY

The present invention has been made in view of such circumstances, and aims at estimating information indicating ripeness at harvest time at a stage after the harvest time.

A harvest-time ripeness estimation device according to an aspect of the present invention includes: a first optical data acquisition unit configured to acquire first optical data obtained by applying light of a first wavelength to a fruit or vegetable at a first time point after harvest time of the fruit or vegetable; a harvest-time ripeness correspondence information storage unit configured to store harvest-time ripeness correspondence information indicating correspondence relation between ripeness at the harvest time of the fruit or vegetable and a value of the first optical data with respect to the light of the first wavelength; and a harvest-time ripeness estimation unit configured to estimate the ripeness at the harvest time of the fruit or vegetable on the basis of the acquired first optical data and the harvest-time ripeness correspondence information.

In a harvest-time ripeness estimation method according to an aspect of the present invention, a computer acquires first optical data obtained by applying light of a first wavelength to a fruit or vegetable at a first time point after harvest time of the fruit or vegetable, and estimates ripeness at the harvest time of the fruit or vegetable, on the basis of harvest-time ripeness correspondence information indicating correspondence relation between the ripeness at the harvest time of the fruit or vegetable and a value of the first optical data with respect to the light of the first wavelength, and the acquired first optical data.

A program according to an aspect of the present invention is a program for causing a computer to implement: a function of acquiring first optical data obtained by applying light of a first wavelength to a fruit or vegetable at a first time point after harvest time of the fruit or vegetable; and a function of estimating ripeness at the harvest time of the fruit or vegetable on the basis of harvest-time ripeness correspondence information indicating correspondence relation between the ripeness at the harvest time of the fruit or vegetable and a value of the first optical data with respect to the light of the first wavelength, and the acquired first optical data.

In the present invention, the “unit” does not simply mean physical means, and includes a case where the function which the “unit” has is implemented by software. Additionally, the function which one “unit” or device has may be implemented by two or more physical means or devices, or the functions of two or more “units” or devices may be implemented by one physical means or device.

According to the present invention, information indicating ripeness at harvest time can be estimated at a stage after the harvest time.

### DESCRIPTION OF DRAWINGS

FIG. 1 is a diagram showing a configuration of a harvest-time ripeness estimation device according to a first embodiment of the present invention;

FIG. 2 is a diagram showing an example of a reflectivity for each harvest-time ripeness of an Irwin mango;

FIG. 3 is a diagram showing difference values from reflectivities of previous wavelengths in the reflectivities shown in FIG. 2;

FIG. 4 is a diagram showing an example of harvest-time ripeness correspondence information;

FIG. 5 is a flowchart showing an example of processing of estimating harvest-time ripeness;

FIG. 6 is a diagram showing a configuration of a harvest-time ripeness estimation device according to a second embodiment of the present invention;

FIG. 7 is a diagram showing an example of a quality transition model for each harvest-time ripeness of an Irwin mango;

FIG. 8 is a flowchart showing an example of the processing of determining the quality transition model;

FIG. 9 is a diagram showing a configuration of a harvest-time ripeness estimation device according to a third embodiment of the present invention;

FIG. 10 is an example of plotting current values of reflectivity summations on a graph shown in FIG. 7;

FIG. 11 is a flowchart showing an example of the processing of predicting future quality of a vegetable or fruit;

FIG. 12 is a diagram showing a configuration of a harvest-time ripeness estimation device according to a fourth embodiment of the present invention;

FIG. 13 is a diagram showing an example of the reflectivities of an Irwin mango and a Keats mango; and

FIG. 14 is a flowchart showing an example of the processing of predicting quality in view of the variety of a vegetable and fruit.

### DETAILED DESCRIPTION

Hereinafter, an embodiment of the present invention will be described with reference to the drawings.

### First Embodiment

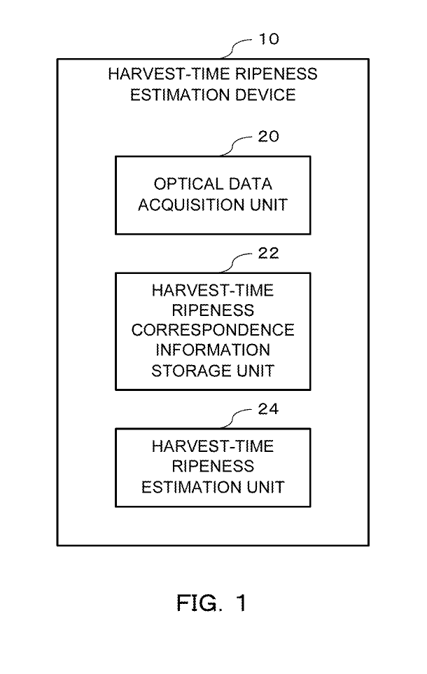

FIG. 1 is a diagram showing a configuration of a harvest-time ripeness estimation device according to a first embodiment of the present invention. A harvest-time ripeness estimation device 10 is a device for estimating ripeness at the harvest time of a fruit or vegetable, namely, harvest-time ripeness, and is achieved by a portable terminal such as a handy terminal, or an information processing device such as a personal computer and a server. As shown in FIG. 1, the harvest-time ripeness estimation device 10 includes an optical data acquisition unit 20, a harvest-time ripeness correspondence information storage unit 22, and a harvest-time ripeness estimation unit 24. Here, the respective units of the harvest-time ripeness estimation device 10 can be achieved by using a storage area of a memory, a storage device or the like, or by executing a program stored in the storage area with a processor.

The optical data acquisition unit 20 acquires optical data obtained by applying light of a specific wavelength to the fruit or vegetable. Here, the light of the specific wavelength is light of a wavelength capable of distinguishing values of optical data according to harvest-time ripeness, and may be light of a single wavelength or light of a plurality of wavelengths. The optical data is data obtained by applying light to the fruit or vegetable, and, for example, a reflectivity, transmittance or the like. Additionally, image data obtained by imaging the fruit or vegetable, which is data obtained by applying light such as natural light to the fruit or vegetable, is also included in the optical data. The optical data acquisition unit 20 can store the obtained optical data in a memory or the like in order to use the optical data in a subsequent process. Additionally, the optical data acquisition unit 20 may include an application unit for applying light, a measurement unit measuring the intensity of reflected light or transmitted light, or a data generation unit generating the optical data on the basis of the result of the measurement. The optical data acquisition unit 20 may acquire the optical data generated outside the harvest-time ripeness estimation device 10 through a cable or a network. While a reflectivity is mainly used as the optical data in this embodiment, any types of optical data as described above may be used.

The harvest-time ripeness correspondence information storage unit 22 stores harvest-time ripeness correspondence information indicating correspondence relation between harvest-time ripeness and a value of optical data acquired by applying the specific wavelength to the fruit or vegetable. Here, the specific wavelength used when the harvest-time ripeness is estimated is determined on the basis of an advance experiment or the like. For example, the reflectivity is greatly changed by the ripeness at the harvest time, but is almost unchanged at a ripening stage after harvesting. That is, a wavelength range capable of estimating the ripeness at the harvest time can be selected as the specific wavelength.

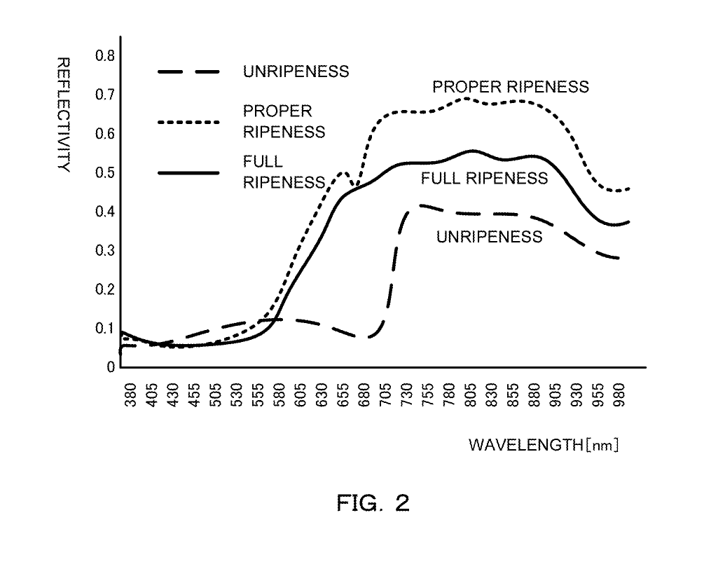

An example of difference in reflectivity by the harvest-time ripeness will be described. FIG. 2 is a diagram showing an example of a reflectivity for each harvest-time ripeness in a certain time point after harvesting of an Irwin mango. FIG. 2 shows three kinds, namely unripeness, proper ripeness and full ripeness as the harvest-time ripeness. In FIG. 2, the “reflectivity” of a longitudinal axis indicates a ratio to the reflectivity in a case of using barium sulfate as a white standard material. A horizontal axis in FIG. 2 indicates a wavelength. Note that the reflectivity in the wavelength range in which a substance serving as an index of quality has a wavelength of maximum absorption is inversely proportional to the abundance of the substance. That is, increase in the reflectivity means deterioration in the quality.

In a graph of FIG. 2, in a case where the harvest-time ripeness is unripeness, for example, the reflectivities at wavelengths of 600 to 700 nm are lower than those of other two harvest-time ripeness. Therefore, it is possible to construct estimation algorithm that the harvest-time ripeness is estimated to be the unripeness, when the reflectivity average value at wavelengths of 600 to 700 nm is less than 0.3, for example.

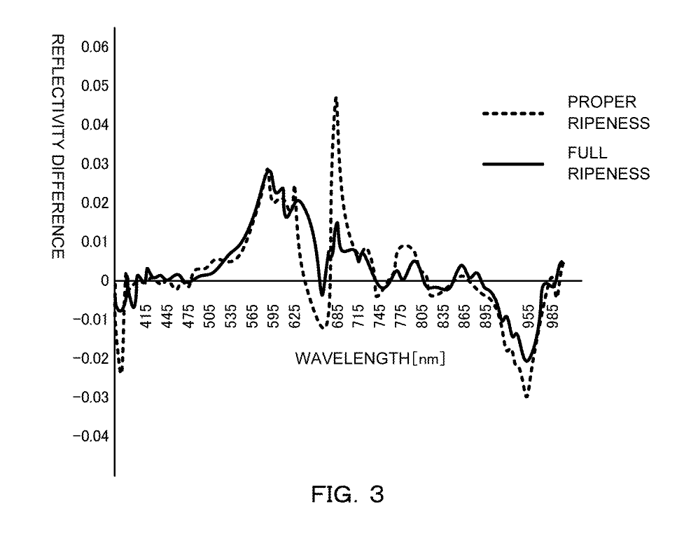

FIG. 3 shows difference from reflectivities of previous wavelengths in the reflectivities shown in FIG. 2. In a graph of FIG. 3, for example, in a region of wavelengths of 685 to 715 nm, difference values in a case where the harvest-time ripeness is the proper ripeness are larger than those in a case where the harvest-time ripeness is the full ripeness. Therefore, it is possible to construct estimation algorithm that the harvest-time ripeness is estimated to be the proper ripeness when the summation of reflectivity difference at wavelengths of 685 to 715 nm is 0.1 or more, and the harvest-time ripeness is estimated to be the full ripeness when the summation is less than 0.1, for example.

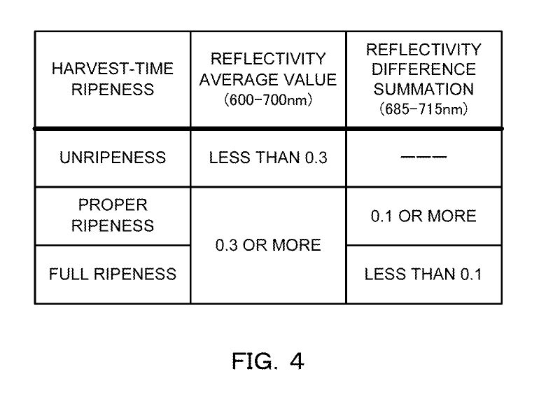

The harvest-time ripeness correspondence information indicating the correspondence relation between the values of the optical data and the harvest-time ripeness is generated on the basis of the estimation algorithm thus constructed, and stored in the harvest-time ripeness correspondence information storage unit 22. FIG. 4 shows an example of the harvest-time ripeness correspondence information based on the constructed estimation algorithm. As long as the correspondence relation between the values of the optical data and the harvest-time ripeness can be indicated, any data form of the harvest-time ripeness correspondence information may be employed. For example, the harvest-time ripeness correspondence information can be information in a table form shown in FIG. 4, or a form in which the harvest-time ripeness is buried in a program for estimation.

The aforementioned estimation algorithm is an example, and any algorithm capable of distinguishing harvest-time ripeness by values of optical data can be employed. For example, in order to determine whether or not the harvest-time ripeness is unripeness, it is considered that flatness of reflectivities in the region of wavelengths of 600 to 700 nm is evaluated. Specifically, the degree of change in reflectivity in this wavelength region may be calculated by obtaining a derivative value or a difference value from a previous wavelength, and flatness may be evaluated from the degree of this change. For example, as to determination of the proper ripeness and the full ripeness, it is also considered that a second derivative values in a previous or next region of wavelengths of 685 to 715 nm are calculated, and the harvest-time ripeness is determined to be the proper ripeness when the degree of the change of the derivative values is large, otherwise the harvest-time ripeness is determined to be the full ripeness.

FIG. 2 and FIG. 3 each are an example of data obtained from an individual, and estimation algorithm may be constructed by acquiring optical data of a large number of individuals when constructing the estimation algorithm, and defining input and output as optical data and harvest-time ripeness, respectively, and causing a discriminator such as a SVM (Support Vector Machine) and a GLVQ (Generalized Learning Vector Quantization) to learn. Alternatively, the harvest-time ripeness estimation device 10 may be provided with a harvest-time ripeness correspondence information generation unit constructing estimation algorithm on the basis of optical data, a large number of individuals of which is acquired by the optical data acquisition unit 20, and generating harvest-time ripeness correspondence information.

Returning to FIG. 1, the harvest-time ripeness estimation unit 24 estimates the harvest-time ripeness on the basis of the optical data acquired by the optical data acquisition unit 20, and the harvest-time ripeness correspondence information stored in the harvest-time ripeness correspondence information storage unit 22. The harvest-time ripeness estimation unit 24 can store information indicating an estimation result in a memory or the like in order to use in a subsequent process. Additionally, the harvest-time ripeness estimation unit 24 may display the information indicating the estimation result on a monitor of the harvest-time ripeness estimation device 10, may output the information to other information processing device, or may print the information from a printer.

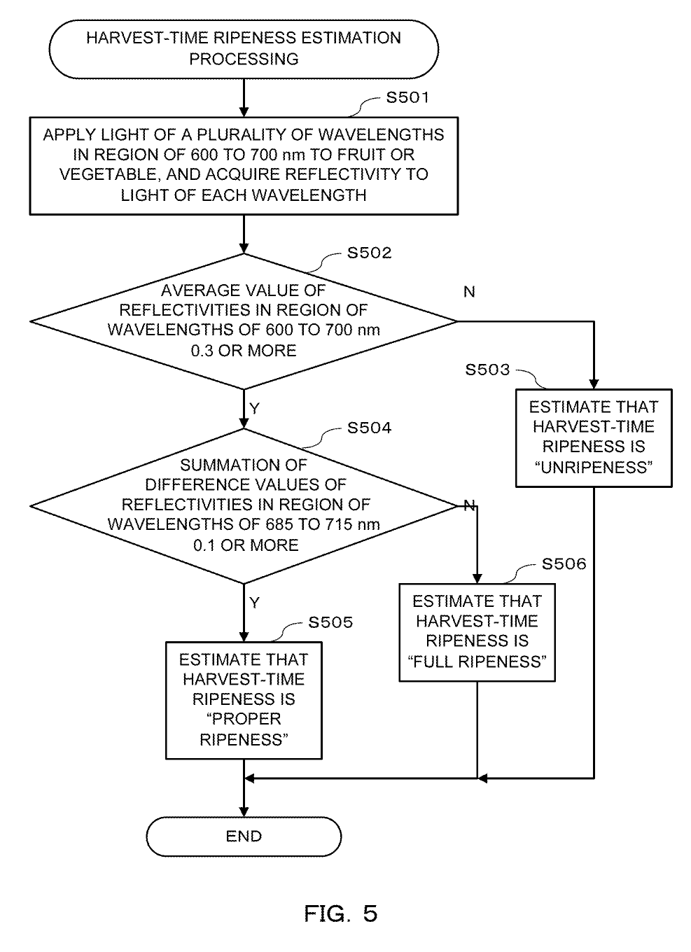

FIG. 5 is a flowchart showing an example of the processing of estimating the harvest-time ripeness. First, the optical data acquisition unit 20 applies light of a plurality of wavelengths in a region, for example, of wavelengths of 600 to 700 nm to a fruit or vegetable, and acquires a reflectivity to the light of each wavelength to store the same in the memory or the like (S501).

The harvest-time ripeness estimation unit 24 calculates the average value of the reflectivities in the region of wavelengths of 600 to 700 nm, which are acquired by the optical data acquisition unit 20, and determines with reference to the harvest-time ripeness correspondence information storage unit 22 whether or not the calculated average value is at least 0.3 being a reference value in determining whether or not the harvest-time ripeness is unripeness (S502). Then, when the calculated average value is less than 0.3 (S502: N), the harvest-time ripeness estimation unit 24 estimates that the harvest-time ripeness is the unripeness (S503).

When the calculated average is 0.3 or more (S502: Y), the harvest-time ripeness estimation unit 24 calculates the summation of the difference values of the reflectivities in the region of wavelengths of 685 to 715 nm, which are acquired by the optical data acquisition unit 20, and determines with reference to the harvest-time ripeness correspondence information storage unit 22 whether or not the calculated summation is at least 0.1 being a reference value in determining the harvest-time ripeness is proper ripeness or full ripeness (S504). Then, when the calculated summation is 0.1 or more (S504: Y), the harvest-time ripeness estimation unit 24 estimates that the harvest-time ripeness is the proper ripeness (S505). When the calculated summation is less than 0.1 (S504: N), the harvest-time ripeness estimation unit 24 estimates that harvest-time ripeness is the full ripeness (S506).

In the processing shown in FIG. 5, the harvest-time ripeness includes three kinds, namely, the unripeness, the proper ripeness and the full ripeness. However, in a case where the harvest-time ripeness is the intermediate of these, a more fuzzy system, such as a system of combining algorithm for estimating the unripeness, the proper ripeness and the full ripeness, can be employed. For example, the degrees of attributing to the three of the unripeness, the proper ripeness and the full ripeness can be represented by likelihood indexes from the indexes by the aforementioned reflectivities. Specifically, for example, in a case where the summation of the difference values of the reflectivities in the region of wavelengths of 685 to 715 nm is 0.08, the harvest-time ripeness is estimated to be the full ripeness in the processing shown in FIG. 5, but may be estimated according to the difference from 0.1 being the reference value, for example, may be estimated by defining the likelihood of the full ripeness as 0.6, and defining the likelihood of the proper ripeness as 0.4. Note that numerical values shown in here are an example, and any calculation criterion of likelihood can be set.

The harvest-time ripeness estimation device 10 of the first embodiment has been described as above. According to such a harvest-time ripeness estimation device 10, it is possible to estimate the harvest-time ripeness of a fruit or vegetable at a stage after the harvest time. Consequently, it is possible to determine a quality transition model, or to predict quality on the basis of the estimated harvest-time ripeness, as described later. For example, it is possible to perform branding or to select the fruit or vegetable at a distribution stage, by using the estimated harvest-time ripeness.

### Second Embodiment

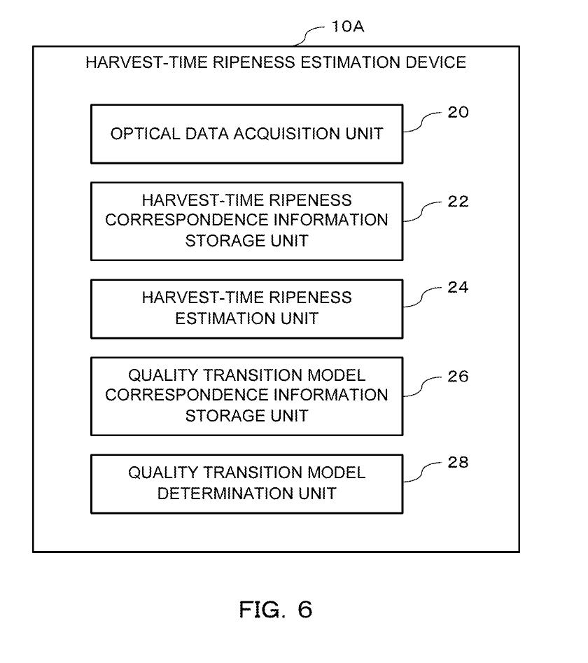

FIG. 6 is a diagram showing a configuration of a harvest-time ripeness estimation device according to a second embodiment of the present invention. As shown in FIG. 6, a harvest-time ripeness estimation device 10A includes a quality transition model correspondence information storage unit 26, and a quality transition model determination unit 28, in addition to the configuration of the harvest-time ripeness estimation device 10 of the first embodiment. Here, the respective units of the harvest-time ripeness estimation device 10A can be achieved by using a storage area of a memory, a storage device or the like, or by executing a program stored in the storage area with a processor. The same configurations as those of the harvest-time ripeness estimation device 10 of the first embodiment are denoted by the same reference numerals, and description thereof will be omitted.

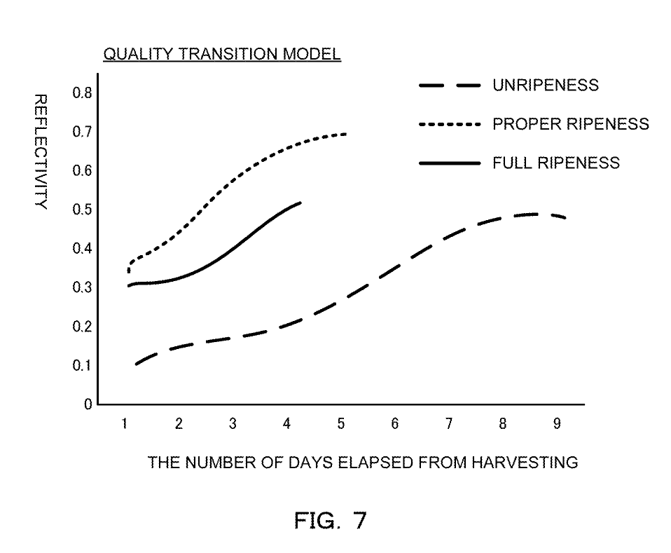

The quality transition model correspondence information storage unit 26 stores quality transition model correspondence information indicating the correspondence relation between harvest-time ripeness of a fruit or vegetable and a quality transition model. Here, the quality transition model indicates the transition of quality over time from harvesting of the fruit or vegetable. FIG. 7 shows an example of the quality transition model for each harvest-time ripeness of an Irwin mango. In FIG. 7, the “reflectivity” of a longitudinal axis indicates the reflectivity summation at wavelengths of 675 nm to 685 nm shown in FIG. 2. A horizontal axis of FIG. 7 indicates the number of days from the harvesting. The quality transition model can be constructed for each harvest-time ripeness on the basis of advance experiment results, similarly to the harvest-time ripeness correspondence information.

Here, chlorophyll being an index indicating the quality of a plant is an enzyme taking an important role in photosynthesis of the plant, the wavelength of maximum absorption thereof exists at 680 nm. It is known that a chlorophyll amount is reduced after the plant is harvested, and related to the quality of the plant. The reflectivity summations at 675 nm to 685 nm being around the wavelength of maximum absorption of chlorophyll have a positive correlation with reduction of the chlorophyll amount. That is, in a graph of FIG. 7, the reflectivity shown by the longitudinal axis is an index which is inversely proportional to the chlorophyll amount. Therefore, for example, when a case where the harvest-time ripeness is unripeness is compared with a case where the harvest-time ripeness is proper ripeness, it can be confirmed that even the initial values of the chlorophyll amounts at harvest time are almost the same, the degrees of reduction after the harvest time are different, namely, the process of quality deterioration is different depending on the harvest-time ripeness.

In FIG. 7, the final number of days elapsed differs depending on the harvest-time ripeness. This is because the number of days being generally good time for eating is indicated as a final day, and it is possible to construct a quality transition model for a longer period of time by summing up optical data over the number of days.

While the reflectivity summations at wavelengths of 675 nm to 685 nm are shown as an example of quality in FIG. 7, the index indicating quality is not limited to this, and any index can be used.

For example, ripening type citrus fruits such as mangos and apples secrete wax in the process of ripening, the amount of wax can be used as an index of indicating how much the ripening progresses. For example, reflectivity summations at wavelengths of 800 nm to 900 nm, which indicates the amount of secretion wax characteristic of the ripening type citrus fruits, may be used.

As shown in the following formula (1), a quality index P obtained by combining a plurality of quality indexes may be used.

P=α×C1+β×C2+γ×C3 (1)

C1, C2 and C3 denotes respective different quality indexes, and α, β and γ denote coefficients indicating weighting of the respective quality indexes.

The quality index indicated by the quality transition model is not limited to an index based on optical data, and may be an index indicating the quality transition of a fruit or vegetable. For example, a sugar content rise model tailored to the harvest-time ripeness by previously constructing a rise model of a quality index rising in the process of ripening like a Brix sugar content can be used as the quality transition model.

The quality transition model correspondence information storage unit 26 stores quality transition model correspondence information indicating the correspondence relation between the quality transition model constructed as described above, and the harvest-time ripeness. As long as the correspondence relation between the quality transition model and the harvest-time ripeness can be indicated, any data form of the quality transition model correspondence information may be employed. For example, the quality transition model correspondence information can be information where values of a graph shown in FIG. 7 are associated with the harvest-time ripeness.

Returning to FIG. 6, the quality transition model determination unit 28 determines the quality transition model indicating the quality transition of a fruit or vegetable on the basis of the harvest-time ripeness estimated by the harvest-time ripeness estimation unit 24, and the quality transition model correspondence information stored in the quality transition model correspondence information storage unit 26. The quality transition model determination unit 28 can store information indicating the determined quality transition model in a memory or the like in order to use in a subsequent process. Additionally, the quality transition model determination unit 28 may display the information indicating the determined quality transition model on a monitor of the harvest-time ripeness estimation device 10A, may output the information to other information processing device, or may print the information from a printer.

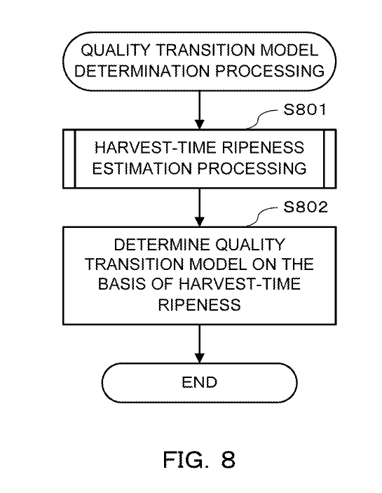

FIG. 8 is a flowchart showing an example of the processing of determining the quality transition model. Here, it is assumed that the harvest-time ripeness is estimated by the processing shown in FIG. 5 (S801). The quality transition model determination unit 28 determines the quality transition model corresponding to the estimated harvest-time ripeness with reference to the quality transition model correspondence information storage unit 26 (S802).

As described in the first embodiment, in a case of estimating the intermediate harvest-time ripeness of unripeness, proper ripeness, and full ripeness by using likelihood, a system of combining a plurality of quality transition models can be used also for the quality transition model determined in FIG. 8. For example, in a case where the likelihood of the unripeness is a, and the likelihood of the proper ripeness is 1-a, the quality transition model determination unit 28 can generate a quality transition model where the quality transition model of the unripeness and the quality transition model of the proper ripeness are combined in the ratio of α:1-α.

The harvest-time ripeness estimation device 10A of the second embodiment has been described as above. According to such a harvest-time ripeness estimation device 10A, it is possible to determine the quality transition model on the basis of the estimated harvest-time ripeness at a stage after the harvest time. Consequently, it is possible to predict future quality on the basis of the determined quality transition model, or to perform branding or to select the fruit or vegetable at a distribution stage by using the determined quality transition model.

### Third Embodiment

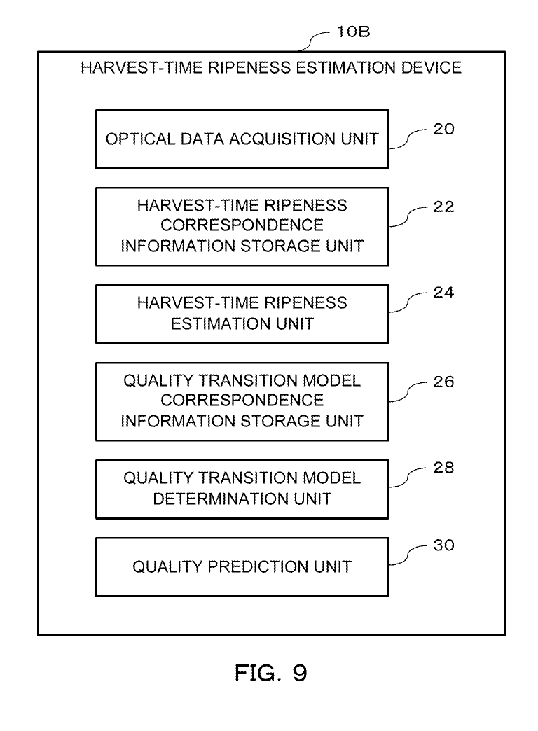

FIG. 9 is a diagram showing a configuration of a harvest-time ripeness estimation device according to a third embodiment of the present invention. As shown in FIG. 9, a harvest-time ripeness estimation device 10B includes a quality prediction unit 30, in addition to the configuration of the harvest-time ripeness estimation device 10A of the second embodiment. Here, the respective units of the harvest-time ripeness estimation device 10B can be achieved by using a storage area of a memory, a storage device or the like, or by executing a program stored in the storage area with a processor. The same configurations as those of the harvest-time ripeness estimation device 10A of the second embodiment are denoted by the same reference numerals, and description thereof will be omitted.

The quality prediction unit 30 predicts future quality of a fruit or vegetable on the basis of optical data acquired by an optical data acquisition unit 20, and a quality transition model determined by a quality transition model determination unit 28. Here, the quality may be any of, for example, a chlorophyll amount, a wavelength of maximum reflection of a substance suggesting a sugar content, combination of a plurality of quality indexes as described in the second embodiment, and the like.

For example, in a case where the quality transition model is a model indicating the transition of the deterioration of quality over time, the quality prediction unit 30 can predict the number of days until the quality reaches a predetermined reference level or less, namely, a life of the fruit or vegetable, on the basis of the optical data acquired by the optical data acquisition unit 20, and the quality transition model determined by the quality transition model determination unit 28.

For example, in a case where the quality transition model is a model indicating the transition of quality improving over time, the quality prediction unit 30 can predict the number of days until the quality reaches the predetermined reference level or more, namely, the number of days until the fruit or vegetable becomes good for eating, on the basis of the optical data acquired by the optical data acquisition unit 20, and the quality transition model determined by the quality transition model determination unit 28.

The quality prediction unit 30 can store information indicating the predicted quality in a memory or the like in order to use in a subsequent process. Additionally, the quality prediction unit 30 may display the information indicating the predicted quality on a monitor of the harvest-time ripeness estimation device 10B, may output the information to other information processing device, or may print the information from a printer.

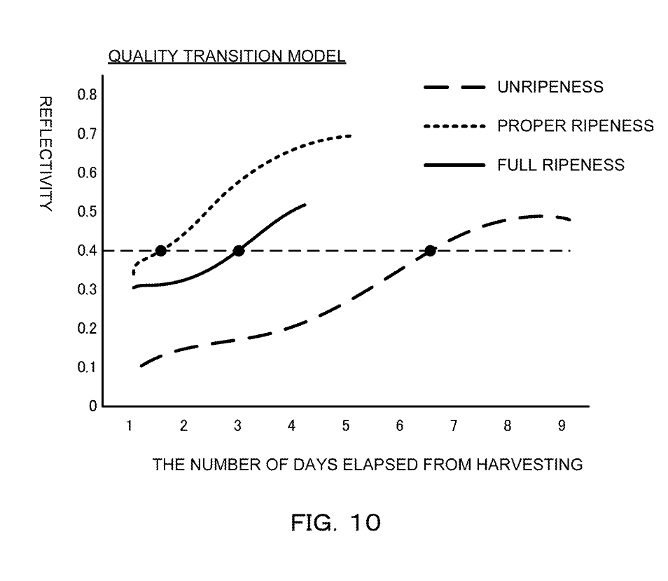

FIG. 10 is an example of plotting current values of reflectivity summations at wavelengths of 675 nm to 685 nm of a fruit or vegetable on a graph shown in FIG. 7. As shown in FIG. 10, it is assumed that a current value of a reflectivity summation at wavelengths of 675 nm to 685 nm of the fruit or vegetable is 0.4. At this time, the number of days until the life differs depending on the quality transition model, namely, harvest-time ripeness. For example, it is assumed that the harvest-time ripeness is estimated to be unripeness, and a quality transition model according to this harvest-time ripeness is determined. In this case, from the quality transition model shown in FIG. 10, the number of days elapsed from harvesting at a current time point is approximately 7 days. Then, in a case where the harvest-time ripeness is unripeness, the life is 9 days from the harvesting, the quality prediction unit 30 can predict that the life of the fruit or vegetable is 2 days.

The value of the reflectivity summation at wavelengths of 675 nm to 685 nm is used as a quality index in quality prediction herein, but the region of the wavelength is not limited to this. Optical data being the basis of the quality index in quality prediction, and optical data being the basis of the estimation of the harvest-time ripeness may be in the same wavelength range, or may be in different wavelength ranges. Additionally, the timing, at which the optical data used when quality is predicted is acquired, may be the same as, or different from the timing, at which the optical data used when the harvest-time ripeness is estimated is acquired.

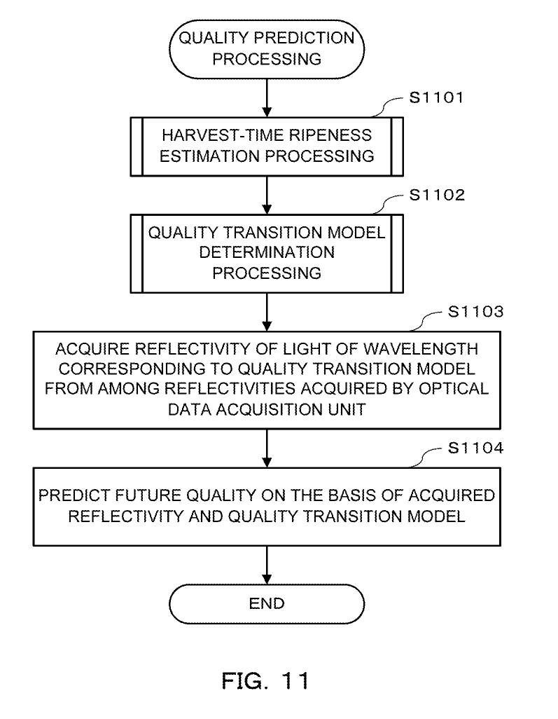

FIG. 11 is a flowchart showing an example of the processing of predicting the future quality of the fruit or vegetable. Here, it is assumed that the harvest-time ripeness is estimated by the process shown in FIG. 5 (S1101), and the quality transition model is determined by the processing shown in FIG. 8 (S1102). The quality prediction unit 30 acquires the reflectivity of light of a wavelength corresponding to the quality transition model determined by the quality transition model determination unit 28, from among reflectivities acquired by the optical data acquisition unit 20 (S1103). Then, the quality prediction unit 30 predicts future quality such as the number of days until the life, on the basis of the acquired reflectivity, and the determined quality transition model (S1104).

As described in the second embodiment, the quality prediction unit 30 can predict future quality by using the quality transition model constructed by considering likelihood.

The harvest-time ripeness estimation device 10B of the third embodiment has been described as above. According to such a harvest-time ripeness estimation device 10B, it is possible to estimate the harvest-time ripeness at a stage after the harvest time, and predict the future quality of the fruit or vegetable by using the quality transition model according to the harvest-time ripeness. As shown in this embodiment, the intended use of an individual to be evaluated is easily determined by predicting not a value itself of a quality index in the future, but the number of days until the quality index reaches a reference value. For example, an individual, which is considered to deteriorate up to minimum quality standards tomorrow, is not distributed as it is, but is processed, for example, freeze-dried, or processed into juice, thereby enabling action, such as prevention of the individual from decomposition in a distribution process and disposal, to be taken. Additionally, also at a time point when a fruit or vegetable is delivered to a consumer, each consumer knows the life of the individual, thereby enabling the consumer to consume the individual before the life thereof. This can prevent a loss due to quality deterioration. Furthermore, the fruit or vegetable, the life of which can be accurately predicted, is secure and safe for a consumer, and hence branding is also enabled.

### Fourth Embodiment

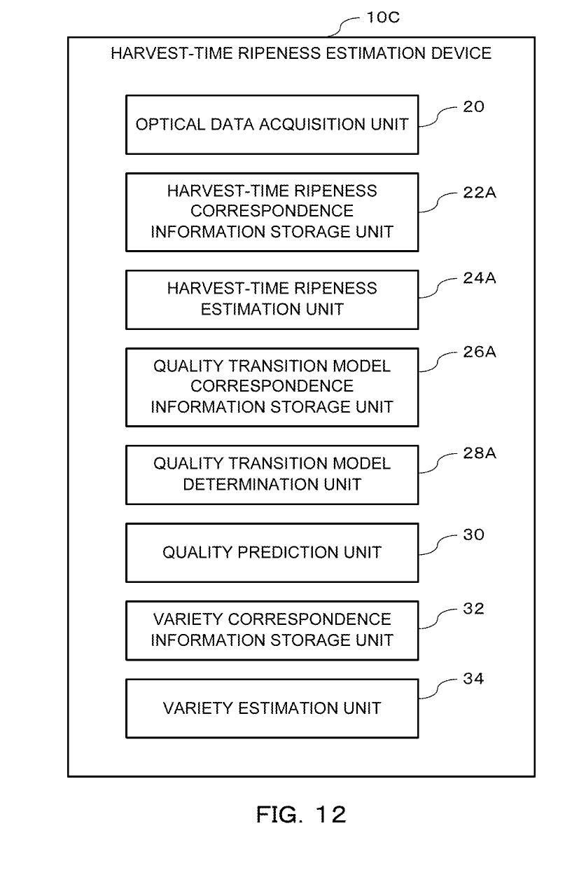

FIG. 12 is a diagram showing a configuration of a harvest-time ripeness estimation device according to a fourth embodiment of the present invention. As shown in FIG. 12, a harvest-time ripeness estimation device 10C includes a variety correspondence information storage unit 32 and a variety estimation unit 34, in addition to the configuration of the harvest-time ripeness estimation device 10B of the third embodiment. The harvest-time ripeness estimation device 10C includes a harvest-time ripeness correspondence information storage unit 22A, a harvest-time ripeness estimation unit 24A, a quality transition model correspondence information storage unit 26A, and a quality transition model determination unit 28A, which are configured by adding the functions of considering varieties to the harvest-time ripeness correspondence information storage unit 22, the harvest-time ripeness estimation unit 24, the quality transition model correspondence information storage unit 26, and the quality transition model determination unit 28 in the harvest-time ripeness estimation device 10B of the third embodiment. Here, the respective units of the harvest-time ripeness estimation device 10C can be achieved, for example, by using a storage area of a memory, a storage device or the like, or by executing a program stored in the storage area with a processor. The same configurations as those of the harvest-time ripeness estimation device 10B of the third embodiment are denoted by the same reference numerals, and description thereof will be omitted.

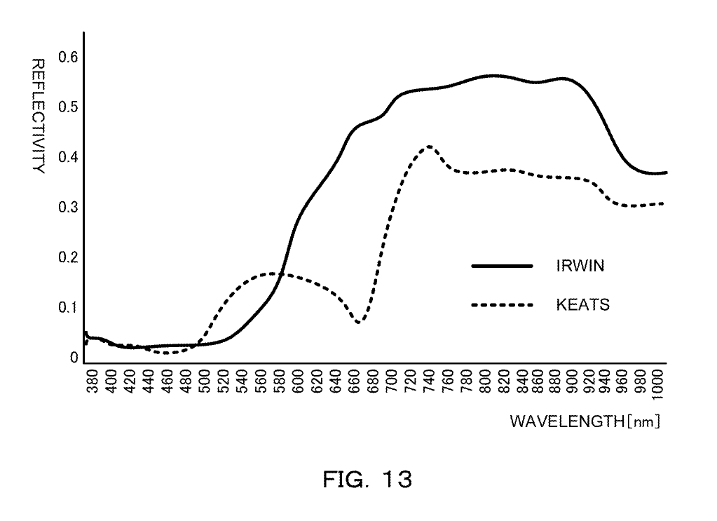

The variety correspondence information storage unit 32 stores variety correspondence information indicating the correspondence relation between a value of optical data acquired by the optical data acquisition unit 20 and a variety of a fruit or vegetable. FIG. 13 shows an example of reflectivities at a certain time point after harvesting of an Irwin mango and a Keats mango. As shown in FIG. 13, in a specific wavelength range, a reflectivity characteristic differs depending on a variety of mango. Therefore, it is possible to generate the variety correspondence information indicating the correspondence relation between the value of the optical data and the variety of the fruit or vegetable and to store the same in the variety correspondence information storage unit 32, similarly to the case of the harvest-time ripeness correspondence information, on the basis of such a measurement result. The optical data used herein is not required to indicate the quality of the fruit or vegetable, and for example, may be image data obtained by imaging the fruit or vegetable.

The variety estimation unit 34 can estimate the variety of the fruit or vegetable on the basis of the optical data acquired by the optical data acquisition unit 20, and the variety correspondence information stored in the variety correspondence information storage unit 32. For example, the variety estimation unit 34 can estimate the variety of the fruit or vegetable on the basis of the reflectivity of light in the specific wavelength range, or can estimate the variety of the fruit or vegetable on the basis of a shape or color.

Optical data being the basis of variety estimation, and optical data being the basis of the estimation of the harvest-time ripeness or future quality prediction may be in the same wavelength range, or may be in different wavelength ranges. Additionally, the timing, at which the optical data used when variety is estimated is acquired, may be the same as, or different from the timing, at which the optical data used when the harvest-time ripeness is estimated or future quality is predicted is acquired.

The harvest-time ripeness correspondence information storage unit 22A associates and stores harvest-time ripeness correspondence information with the variety. Then, the harvest-time ripeness estimation unit 24A can acquire the harvest-time ripeness correspondence information according to the variety estimated by the variety estimation unit 34 from the harvest-time ripeness correspondence information storage unit 22A, and estimate harvest-time ripeness, similarly to the case of the harvest-time ripeness estimation unit 24 in other embodiments.

The quality transition model correspondence information storage unit 26A associates and stores quality transition model correspondence information with the variety. Then, the quality transition model determination unit 28A can acquire the quality transition model correspondence information according to the variety estimated by the variety estimation unit 34 from the quality transition model correspondence information storage unit 26A, and determine a quality transition model, similarly to the case of the quality transition model determination unit 28 in other embodiments.

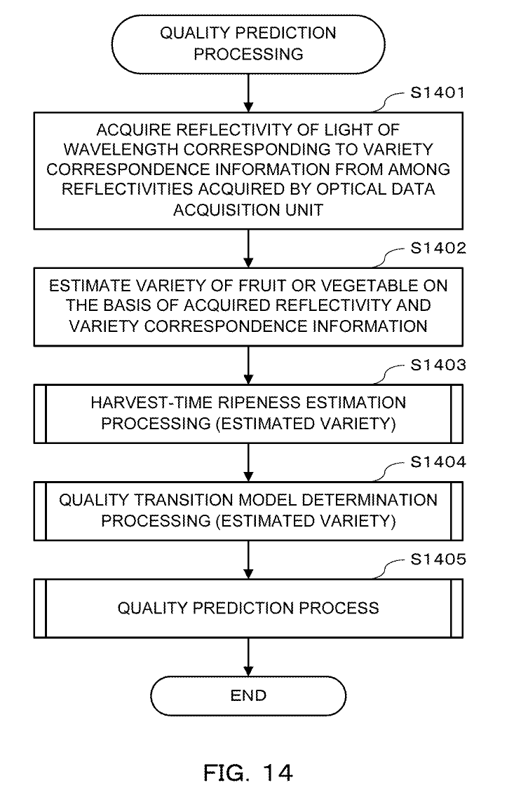

FIG. 14 is a flowchart showing an example of the processing of predicting quality in consideration of the variety of a fruit or vegetable. First, the variety estimation unit 34 acquires the reflectivity of light of a wavelength corresponding to the variety correspondence information stored in the variety correspondence information storage unit 32, from among reflectivities acquired by the optical data acquisition unit 20 (S1401). Then, the variety estimation unit 34 estimates the variety of the fruit or vegetable on the basis of the acquired reflectivity and the variety correspondence information (S1402).

The harvest-time ripeness estimation unit 24A estimates the harvest-time ripeness by processing similar to the processing shown in FIG. 5, after considering the estimated variety (S1403). The quality transition model determination unit 28A determines the quality transition model by processing similar to the processing shown in FIG. 8, after considering the estimated variety (S1404). Then, the quality prediction unit 30 predicts the future quality of the fruit or vegetable by processing similar to the process shown in FIG. 11 (S1405).

The harvest-time ripeness estimation device 10C of the fourth embodiment has been described as above. According to such a harvest-time ripeness estimation device 10C, it is possible to estimate the harvest-time ripeness after considering the variety of the fruit or vegetable, at a stage after the harvest time. Additionally, it is possible to determine the quality transition model after considering the variety, or predict the future quality.

The present embodiments are to facilitate the understanding of the present invention, and not to limit and interpret the present invention. The present invention can be changed/modified without departing the scope thereof, and the present invention includes equivalents thereof.

For example, while the fruit or vegetable is employed as an object to be evaluated in each of the present embodiments, the object to evaluated is not limited to the fruit or vegetable, and the present invention is applicable to an object, for which quality information has an important meaning as a value, such as fresh fish, meats, and processed food.

This application claims the conventional priority based on Japanese Patent Application No. 2011-135385 filed on Jun. 17, 2011, all disclosure of which is incorporated herein.

As described above, the present invention is described with reference to the embodiments, but is not limited to the aforementioned embodiments. The configuration of the present invention can be changed, and specifically, various changes that a person skilled in the art could understand can be made in the scope of the present invention.

A part or all of the present embodiments can be also described as in the following appendixes, but is not limited to the following.

(Appendix 1) A harvest-time ripeness estimation device comprising: a first optical data acquisition unit configured to acquire first optical data obtained by applying light of a first wavelength to a fruit or vegetable at a first time point after harvest time of the fruit or vegetable; a harvest-time ripeness correspondence information storage unit configured to store harvest-time ripeness correspondence information indicating correspondence relation between ripeness at the harvest time of the fruit or vegetable and a value of the first optical data with respect to the light of the first wavelength; and a harvest-time ripeness estimation unit configured to estimate the ripeness at the harvest time of the fruit or vegetable on the basis of the acquired first optical data and the harvest-time ripeness correspondence information.
(Appendix 2) The harvest-time ripeness estimation device according to Appendix 1, further comprising: a quality transition model correspondence information storage unit configured to store quality transition model correspondence information indicating correspondence relation between the ripeness at the harvest time of the fruit or vegetable and a quality transition model; and a quality transition model determination unit configured to determine the quality transition model indicating quality transition of the fruit or vegetable on the basis of the estimated ripeness at the harvest time and the quality transition model correspondence information.
(Appendix 3) The harvest-time ripeness estimation device according to Appendix 2, further comprising: a second optical data acquisition unit configured to acquire second optical data indicating quality of the fruit or vegetable and obtained by applying light of a second wavelength to the fruit or vegetable at a second time point after the harvest time of the fruit or vegetable; and a quality prediction unit configured to predict quality of the fruit or vegetable at a time point after the second time point on the basis of the determined quality transition model indicating transition of the second optical data, and the acquired second optical data.
(Appendix 4) The harvest-time ripeness estimation device according to Appendix 3, wherein the quality transition model indicates transition of quality deteriorating over time, and wherein the quality prediction unit is configured to predict the number of days until the quality of the fruit or vegetable deteriorates to a reference level or below, on the basis of the acquired second optical data and the determined quality transition model.
(Appendix 5) The harvest-time ripeness estimation device according to Appendix 3, wherein the quality transition model indicates transition of quality improving over time, and wherein the quality prediction unit is configured to predict the number of days until the quality of the fruit or vegetable improves to a reference level or above, on the basis of the acquired second optical data and the determined quality transition model.
(Appendix 6) The harvest-time ripeness estimation device according to any one of Appendixes 1 to 5, wherein the first optical data acquisition unit is configured to acquire a plurality of pieces of optical data with respect to light of a plurality of wavelengths as the first optical data with respect to the light of the first wavelength, and wherein the harvest-time ripeness estimation unit is configured to estimate the ripeness at the harvest time of the fruit or vegetable, on the basis of the harvest-time ripeness correspondence information indicating correspondence relation between values of the optical data with respect to the light of the plurality of wavelengths and the ripeness at the harvest time, and the acquired plurality of pieces of optical data.
(Appendix 7) The harvest-time ripeness estimation device according to any one of Appendixes 1 to 6, further comprising: a third optical data acquisition unit configured to acquire third optical data obtained by applying light of a third wavelength to the fruit or vegetable at a third time point after the harvest time of the fruit or vegetable; a variety correspondence information storage unit configured to store variety correspondence information indicating correspondence relation between a variety of the fruit or vegetable and a value of the third optical data with respect to the light of the third wavelength; and a variety estimation unit configured to estimate the variety of the fruit or vegetable on the basis of the acquired third optical data and the variety correspondence information, wherein the harvest-time ripeness correspondence information storage unit is configured to store the harvest-time ripeness correspondence information in association with the variety of the fruit or vegetable, and wherein the harvest-time ripeness estimation unit is configured to estimate the ripeness at the harvest time of the fruit or vegetable on the basis of the acquired first optical data, the estimated variety, and the harvest-time ripeness correspondence information.
(Appendix 8) The harvest-time ripeness estimation device according to any one of Appendixes 1 to 7, wherein the optical data is data indicating a reflectivity or a transmittance of light applied to the fruit or vegetable.
(Appendix 9) A harvest-time ripeness estimation method for causing the computer to execute the steps of: acquiring first optical data obtained by applying light of a first wavelength to a fruit or vegetable at a first time point after harvest time of the fruit or vegetable; and estimating ripeness at the harvest time of the fruit or vegetable, on the basis of harvest-time ripeness correspondence information indicating correspondence relation between the ripeness at the harvest time of the fruit or vegetable and a value of the first optical data with respect to the light of the first wavelength, and the acquired first optical data.
(Appendix 10) The harvest-time ripeness estimation method according to Appendix 9, for causing the computer to further execute the step of determining a quality transition model indicating quality transition of the fruit or vegetable on the basis of quality transition model correspondence information indicating correspondence relation between the ripeness at the harvest time of the fruit or vegetable and the quality transition model, and the estimated ripeness at the harvest time.
(Appendix 11) The harvest-time ripeness estimation method according to Appendix 10, for causing the computer to further execute the steps of: acquiring second optical data indicating quality of the fruit or vegetable and obtained by applying light of a second wavelength to the fruit or vegetable at a second time point after the harvest time of the fruit or vegetable; and predicting quality of the fruit or vegetable at a time point after the second time point on the basis of the determined quality transition model indicating transition of the second optical data, and the acquired second optical data.
(Appendix 12) The harvest-time ripeness estimation method according to Appendix 11, for causing the computer to further execute the step of predicting the number of days until the quality of the fruit or vegetable deteriorates to a reference level or below, on the basis of the determined quality transition model indicating transition of quality deteriorating over time, and the acquired second optical data.
(Appendix 13) The harvest-time ripeness estimation method according to Appendix 11, for causing the computer to further execute the step of predicting the number of days until the quality of the fruit or vegetable improves to a reference level or above, on the basis of the determined quality transition model indicating transition of quality improving over time, and the acquired second optical data.
(Appendix 14) The harvest-time ripeness estimation method according to any one of Appendixes 9 to 13, for causing the computer to further execute the steps of: acquiring a plurality of pieces of optical data with respect to light of a plurality of wavelengths as the first optical data with respect to the light of the first wavelength; and estimating the ripeness at the harvest time of the fruit or vegetable, on the basis of the harvest-time ripeness correspondence information indicating correspondence relation between values of the optical data with respect to the light of the plurality of wavelengths and the ripeness at the harvest time, and the acquired plurality of pieces of optical data.
(Appendix 15) The harvest-time ripeness estimation method according to any one of Appendixes 9 to 14, for causing the computer to further execute the steps of: acquiring third optical data obtained by applying light of a third wavelength to the fruit or vegetable at a third time point after the harvest time of the fruit or vegetable; estimating a variety of the fruit or vegetable, on the basis of the acquired third optical data, and variety correspondence information indicating correspondence relation between the variety of the fruit or vegetable and a value of the third optical data with respect to the light of the third wavelength; and estimating the ripeness at the harvest time of the fruit or vegetable on the basis of the harvest-time ripeness correspondence information associated with the variety of the fruit or vegetable, the acquired first optical data, and the estimated variety.
(Appendix 16) The harvest-time ripeness estimation method according to any one of Appendixes 9 to 15, wherein the optical data is data indicating a reflectivity or a transmittance of light applied to the fruit or vegetable.
(Appendix 17) A program for causing a computer to implement: a function of acquiring first optical data obtained by applying light of a first wavelength to a fruit or vegetable at a first time point after harvest time of the fruit or vegetable; and a function of estimating ripeness at the harvest time of the fruit or vegetable on the basis of harvest-time ripeness correspondence information indicating correspondence relation between the ripeness at the harvest time of the fruit or vegetable and a value of the first optical data with respect to the light of the first wavelength, and the acquired first optical data.
(Appendix 18) The program according to Appendix 17, for causing the computer to further implement a function of determining a quality transition model indicating quality transition of the fruit or vegetable, on the basis of the estimated ripeness at the harvest time, and quality transition model correspondence information indicating correspondence relation between the ripeness at the harvest time of the fruit or vegetable and the quality transition model.
(Appendix 19) The program according to Appendix 18, for causing the computer to further implement: a function of acquiring second optical data indicating quality of the fruit or vegetable and obtained by applying light of a second wavelength to the fruit or vegetable at a second time point after the harvest time of the fruit or vegetable; and a function of predicting quality of the fruit or vegetable at a time point after the second time point on the basis of the determined quality transition model indicating transition of the second optical data, and the acquired second optical data.
(Appendix 20) The program according to Appendix 19, for causing the computer to further implement a function of predicting the number of days until the quality of the fruit or vegetable deteriorates to a reference level or below, on the basis of the determined quality transition model indicating transition of quality deteriorating over time, and the acquired second optical data.
(Appendix 21) The program according to Appendix 19, for causing the computer to further implement a function of predicting the number of days until the quality of the fruit or vegetable improves to a reference level or above, on the basis of the determined quality transition model indicating transition of quality improving over time, and the acquired second optical data.
(Appendix 22) The program according to any one of Appendixes 17 to 21, for causing the computer to further implement: a function of acquiring a plurality of pieces of optical data with respect to light of a plurality of wavelengths as the first optical data with respect to the light of the first wavelength; and a function of estimating the ripeness at the harvest time of the fruit or vegetable, on the basis of the harvest-time ripeness correspondence information indicating correspondence relation between values of the optical data with respect to the light of the plurality of wavelengths and the ripeness at the harvest time, and the acquired plurality of pieces of optical data.
(Appendix 23) The program according to any one of Appendixes 17 to 22, for causing the computer to further implement: a function of acquiring third optical data obtained by applying light of a third wavelength to the fruit or vegetable at a third time point after the harvest time of the fruit or vegetable; a function of estimating a variety of the fruit or vegetable, on the basis of the acquired third optical data, and variety correspondence information indicating correspondence relation between the variety of the fruit or vegetable and a value of the third optical data with respect to the light of the third wavelength; and a function of estimating the ripeness at the harvest time of the fruit or vegetable on the basis of the harvest-time ripeness correspondence information associated with the variety of the fruit or vegetable, the acquired first optical data, and the estimated variety.
(Appendix 24) The program according to any one of Appendixes 17 to 23, wherein the optical data is data indicating a reflectivity or a transmittance of light applied to the fruit or vegetable.
10 HARVEST-TIME RIPENESS ESTIMATION DEVICE
20 OPTICAL DATA ACQUISITION UNIT
22 HARVEST-TIME RIPENESS CORRESPONDENCE INFORMATION STORAGE UNIT
24 HARVEST-TIME RIPENESS ESTIMATION UNIT
26 QUALITY TRANSITION MODEL CORRESPONDENCE INFORMATION STORAGE UNIT
28 QUALITY TRANSITION MODEL DETERMINATION UNIT
30 QUALITY PREDICTION UNIT
32 VARIETY CORRESPONDENCE INFORMATION STORAGE UNIT
34 VARIETY ESTIMATION UNIT

1. A harvest-time ripeness estimation device comprising:
a first optical data acquisition unit configured to acquire first optical data obtained by applying light of a first wavelength to a fruit or vegetable at a first time point after harvest time of the fruit or vegetable;
a harvest-time ripeness correspondence information storage unit configured to store harvest-time ripeness correspondence information indicating correspondence relation between ripeness at the harvest time of the fruit or vegetable and a value of the first optical data with respect to the light of the first wavelength; and
a harvest-time ripeness estimation unit configured to estimate the ripeness at the harvest time of the fruit or vegetable on the basis of the acquired first optical data and the harvest-time ripeness correspondence information.

2. The harvest-time ripeness estimation device according to claim 1, further comprising:
a quality transition model correspondence information storage unit configured to store quality transition model correspondence information indicating correspondence relation between the ripeness at the harvest time of the fruit or vegetable and a quality transition model; and
a quality transition model determination unit configured to determine the quality transition model indicating quality transition of the fruit or vegetable on the basis of the estimated ripeness at the harvest time and the quality transition model correspondence information.

3. The harvest-time ripeness estimation device according to claim 2, further comprising:
a second optical data acquisition unit configured to acquire second optical data indicating quality of the fruit or vegetable and obtained by applying light of a second wavelength to the fruit or vegetable at a second time point after the harvest time of the fruit or vegetable; and
a quality prediction unit configured to predict quality of the fruit or vegetable at a time point after the second time point on the basis of the determined quality transition model indicating transition of the second optical data, and the acquired second optical data.

4. The harvest-time ripeness estimation device according to claim 3,
wherein the quality transition model indicates transition of quality deteriorating over time, and
wherein the quality prediction unit is configured to predict the number of days until the quality of the fruit or vegetable deteriorates to a reference level or below, on the basis of the acquired second optical data and the determined quality transition model.

5. The harvest-time ripeness estimation device according to claim 3,
wherein the quality transition model indicates transition of quality improving over time, and
wherein the quality prediction unit is configured to predict the number of days until the quality of the fruit or vegetable improves to a reference level or above, on the basis of the acquired second optical data and the determined quality transition model.

6. The harvest-time ripeness estimation device according to claim 1,
wherein the first optical data acquisition unit is configured to acquire a plurality of pieces of optical data with respect to light of a plurality of wavelengths as the first optical data with respect to the light of the first wavelength, and
wherein the harvest-time ripeness estimation unit is configured to estimate the ripeness at the harvest time of the fruit or vegetable, on the basis of the harvest-time ripeness correspondence information indicating correspondence relation between values of the optical data with respect to the light of the plurality of wavelengths and the ripeness at the harvest time, and the acquired plurality of pieces of optical data.

7. The harvest-time ripeness estimation device according to claim 1, further comprising:
a third optical data acquisition unit configured to acquire third optical data obtained by applying light of a third wavelength to the fruit or vegetable at a third time point after the harvest time of the fruit or vegetable;
a variety correspondence information storage unit configured to store variety correspondence information indicating correspondence relation between a variety of the fruit or vegetable and a value of the third optical data with respect to the light of the third wavelength; and
a variety estimation unit configured to estimate the variety of the fruit or vegetable on the basis of the acquired third optical data and the variety correspondence information,
wherein the harvest-time ripeness correspondence information storage unit is configured to store the harvest-time ripeness correspondence information in association with the variety of the fruit or vegetable, and
wherein the harvest-time ripeness estimation unit is configured to estimate the ripeness at the harvest time of the fruit or vegetable on the basis of the acquired first optical data, the estimated variety, and the harvest-time ripeness correspondence information.

8. The harvest-time ripeness estimation device according to claim 1, wherein the optical data is data indicating a reflectivity or a transmittance of light applied to the fruit or vegetable.

9. A harvest-time ripeness estimation method for causing the computer to execute the steps of:
acquiring first optical data obtained by applying light of a first wavelength to a fruit or vegetable at a first time point after harvest time of the fruit or vegetable; and
estimating ripeness at the harvest time of the fruit or vegetable, on the basis of harvest-time ripeness correspondence information indicating correspondence relation between the ripeness at the harvest time of the fruit or vegetable and a value of the first optical data with respect to the light of the first wavelength, and the acquired first optical data.

10. The harvest-time ripeness estimation method according to claim 9, for causing the computer to further execute the step of determining a quality transition model indicating quality transition of the fruit or vegetable on the basis of quality transition model correspondence information indicating correspondence relation between the ripeness at the harvest time of the fruit or vegetable and the quality transition model, and the estimated ripeness at the harvest time.

11. The harvest-time ripeness estimation method according to claim 10, for causing the computer to further execute the steps of:
acquiring second optical data indicating quality of the fruit or vegetable and obtained by applying light of a second wavelength to the fruit or vegetable at a second time point after the harvest time of the fruit or vegetable; and
predicting quality of the fruit or vegetable at a time point after the second time point on the basis of the determined quality transition model indicating transition of the second optical data, and the acquired second optical data.

12. The harvest-time ripeness estimation method according to claim 11, for causing the computer to further execute the step of predicting the number of days until the quality of the fruit or vegetable deteriorates to a reference level or below, on the basis of the determined quality transition model indicating transition of quality deteriorating over time, and the acquired second optical data.

13. The harvest-time ripeness estimation method according to claim 11, for causing the computer to further execute the step of predicting the number of days until the quality of the fruit or vegetable improves to a reference level or above, on the basis of the determined quality transition model indicating transition of quality improving over time, and the acquired second optical data.

14. The harvest-time ripeness estimation method according to claim 9, for causing the computer to further execute the steps of:
acquiring a plurality of pieces of optical data with respect to light of a plurality of wavelengths as the first optical data with respect to the light of the first wavelength; and
estimating the ripeness at the harvest time of the fruit or vegetable, on the basis of the harvest-time ripeness correspondence information indicating correspondence relation between values of the optical data with respect to the light of the plurality of wavelengths and the ripeness at the harvest time, and the acquired plurality of pieces of optical data.

15. The harvest-time ripeness estimation method according to claim 9, for causing the computer to further execute the steps of:
acquiring third optical data obtained by applying light of a third wavelength to the fruit or vegetable at a third time point after the harvest time of the fruit or vegetable;
estimating a variety of the fruit or vegetable, on the basis of the acquired third optical data, and variety correspondence information indicating correspondence relation between the variety of the fruit or vegetable and a value of the third optical data with respect to the light of the third wavelength; and
estimating the ripeness at the harvest time of the fruit or vegetable on the basis of the harvest-time ripeness correspondence information associated with the variety of the fruit or vegetable, the acquired first optical data, and the estimated variety.

16. The harvest-time ripeness estimation method according to claim 9, wherein the optical data is data indicating a reflectivity or a transmittance of light applied to the fruit or vegetable.

17. A computer readable storage medium storing a program for causing a computer to implement:
a function of acquiring first optical data obtained by applying light of a first wavelength to a fruit or vegetable at a first time point after harvest time of the fruit or vegetable; and
a function of estimating ripeness at the harvest time of the fruit or vegetable on the basis of harvest-time ripeness correspondence information indicating correspondence relation between the ripeness at the harvest time of the fruit or vegetable and a value of the first optical data with respect to the light of the first wavelength, and the acquired first optical data.

18. The computer readable storage medium according to claim 17, for causing the computer to further implement a function of determining a quality transition model indicating quality transition of the fruit or vegetable, on the basis of the estimated ripeness at the harvest time, and quality transition model correspondence information indicating correspondence relation between the ripeness at the harvest time of the fruit or vegetable and the quality transition model.

19. The computer readable storage medium according to claim 18, for causing the computer to further implement:
a function of acquiring second optical data indicating quality of the fruit or vegetable and obtained by applying light of a second wavelength to the fruit or vegetable at a second time point after the harvest time of the fruit or vegetable; and
a function of predicting quality of the fruit or vegetable at a time point after the second time point on the basis of the determined quality transition model indicating transition of the second optical data, and the acquired second optical data.

20. The computer readable storage medium according to claim 19, for causing the computer to further implement a function of predicting the number of days until the quality of the fruit or vegetable deteriorates to a reference level or below, on the basis of the determined quality transition model indicating transition of quality deteriorating over time, and the acquired second optical data.

21. The computer readable storage medium according to claim 19, for causing the computer to further implement a function of predicting the number of days until the quality of the fruit or vegetable improves to a reference level or above, on the basis of the determined quality transition model indicating transition of quality improving over time, and the acquired second optical data.

22. The computer readable storage medium according to claim 17, for causing the computer to further implement:
a function of acquiring a plurality of pieces of optical data with respect to light of a plurality of wavelengths as the first optical data with respect to the light of the first wavelength; and
a function of estimating the ripeness at the harvest time of the fruit or vegetable, on the basis of the harvest-time ripeness correspondence information indicating correspondence relation between values of the optical data with respect to the light of the plurality of wavelengths and the ripeness at the harvest time, and the acquired plurality of pieces of optical data.

23. The computer readable storage medium according to claim 17, for causing the computer to further implement:
a function of acquiring third optical data obtained by applying light of a third wavelength to the fruit or vegetable at a third time point after the harvest time of the fruit or vegetable;
a function of estimating a variety of the fruit or vegetable, on the basis of the acquired third optical data, and variety correspondence information indicating correspondence relation between the variety of the fruit or vegetable and a value of the third optical data with respect to the light of the third wavelength; and
a function of estimating the ripeness at the harvest time of the fruit or vegetable on the basis of the harvest-time ripeness correspondence information associated with the variety of the fruit or vegetable, the acquired first optical data, and the estimated variety.

24. The computer readable storage medium according to claim 17, wherein the optical data is data indicating a reflectivity or a transmittance of light applied to the fruit or vegetable.
